(19) United States
(12) Patent Application Publication
(10) Pub. No.: US 2026/0131223 A1
(43) Pub. Date: May 14, 2026

(54) Card Game and Method Therefor

(71) Applicants: Anjun Gu, San Diego, CA (US); Isaiah Gu, San Diego, CA (US)

(72) Inventors: Anjun Gu, San Diego, CA (US); Isaiah Gu, San Diego, CA (US)

(21) Appl. No.: 19/388,902

(22) Filed: Nov. 13, 2025

Related U.S. Application Data
(60) Provisional application No. 63/720,177, filed on Nov. 13, 2024.

(51) Int. Cl. A63F 1/04; A63F 1/00; A63F 13/537

(52) U.S. Cl. CPC A63F 1/04; A63F 2001/008; A63F 2001/0408; A63F 2001/0416; A63F 13/537

(57) ABSTRACT

A multi-player card game is provided, with the goal being the last one left with a positive health point score. The game employs a deck of cards, including attack cards, where attacking players try to reduce the health point score of attacked players. Defense cards included in the deck allow the attacked player to lower or eliminate the reduction in health point score of an attack card. The player who manages to have the last health point score above zero is the winner.

This application claims priority to U.S. Provisional Patent Application Ser. No. 63/720177 filed on Nov. 13, 2024.

### BACKGROUND OF THE INVENTION

### 1. Field of the Invention

The present invention relates to games. More specifically, the invention relates to a multi-player card game with playing cards allowing users to employ strategies of attack and defense toward the goal of being the final player left in the game. A digital version may also be played employing digital versions of the cards.

### 2. Prior Art

### Background of the Invention

For centuries, card games have existed that allow players to follow rules and employ drawn cards to proceed through the game. Many conventional card games employ the typical fifty-two-card deck, which allows for use in diverse games and other activities that can be related to conventional cards.

Such conventional cards and decks conventionally have a double-sided design, where one side of each card in the deck bears a pattern that is identical on all playing cards in the deck. Such ensures that each of the cards, when its value is to be kept secret.

On a second side of each card is a number or image designating a value. This second side of the cards usually bears an image of a suit, as well as the alphanumeric value. This suit is employed in many different ways, for many different games that are played with a conventional fifty-two-card deck.

More recently, many card games have been developed that do not employ the traditional deck of fifty-two cards having four suits. Often, the cards used in these games may have characters printed on the face, where each of the different characters provides different “abilities” or “powers.” Unlike a traditional deck of cards, the value of a given card is not determined by the number of symbols printed on its face, but instead by the “strength” of the character's abilities or powers.

The foregoing background concerning recreational card games and the limitations related therewith are intended to be illustrative and not exclusive, and they do not imply any limitations on the card game device and method of play described and claimed herein. Various other limitations of the related art of card games are well known, or will become apparent to those skilled in the art upon a reading and understanding of the specification below and the accompanying drawings.

### SUMMARY OF THE INVENTION

The card game device and method of play herein disclosed and described includes a deck of playing cards having seventy-three different playable cards therein and score cards or sheets for the players to track their progress, and may also include tokens for players to move upon score cards as the game progresses. It is an object of the game herein to be the last player who has a health point score remaining, where all the other players have had their health score depleted to zero.

There are four types of cards in the playing deck.

A first type of cards is the attack cards, which are played by a first player against a chosen other player. There are thirty-two attack cards of varying attack values between a value of one and a value of nine. For attack cards with a value between 1-7, there are four cards of each value from a value of one to an attack value of seven for a sum of twenty-eight attack cards. For attack cards with a value of eight, there are two attack cards, and for attack cards with a value of nine, there are two attack cards. The current aggregate total of attack cards is thus thirty-two. Of course, the numbers of each card may vary for other versions of the game, as may the total number of health point cards and defense cards. However, their respective functions will not.

Additionally, included in the deck are currently twenty health point cards running from a health value of one to a health value of five. There are four health point cards with a value of 1, and there are four health point cards with a value of 2. There are also four health point cards with a value of three, four health point cards with a value of four, and four health point cards with a value of five. There are also two health point cards with a value of maximum, which, in other words, places the player playing it to their maximum health score. Thus, there are a total of twenty-two health point cards.

A third card type in the card deck includes defense cards. There are nineteen defense cards, and fifteen of those defense cards have a defense value between one and five. This makes three defense cards with a value of one, three defense cards with a value of two, three defense cards with a value of three, three defense cards with a value of four, and three defense cards with a value of five. Additionally included in the defense cards is a “reverse” defense card which, when played, reverses the attack card played against the player playing the reverse card to the attacker. Also included are two “block” cards, which, when played, block a current attack from another player.

In a game, a first player to play is chosen. To do so, each player draws one card from the deck. During this draw, the person who draws a card with the highest point score on it is chosen to go first. Play will continue clockwise from that first player. For this initial draw, special cards (block, reverse, max up health) count as 0 points. If two or more players tie, then those two players repeat the process until there is one player remaining with the highest drawn score.

To play the game, once a first player is chosen, each player may have one token and one scoreboard; however, in the electronic version software operating to that task will provide an electronic scorecard and token or marking for each player, which may be displayed on one or a plurality of computer displays.

At the start of the game, each player places their chosen token on the twenty for their health point on their individual scoreboard, which is the maximum health score or point they may have. As the game progresses, respective players will move their token up and down their scoreboard, depending on the cards which are played against them and/or are defended against. For example, only and in no way limiting, if player A is at seventeen for a health point, and gets attacked by five points, player A would move down from seventeen to twelve. However, if player A has a current health score of three, player A would be out of the game.

During a game, the health point cards may be employed to increase a current health point of a player playing one. A revive card to revive the health point of a player may also be included, whereby that player restores their health point score to twenty. As an example only and in no way limiting, if a player plays a health point card with a value of four, and their current health point is eighteen, their score may only increase to the max health point of twenty. However, if a player plays a health point card valued at four, and their current health point is twelve, their health point score will increase to sixteen. As noted, score cards and tokens may be employed for tracking the health point status of each player.

Also, during gameplay, attack cards are used to lower the health point score of another player. For example, only and in no way limiting, if player A uses an attack card with a value of five against player B, then the health point score of player B moves down five spaces on the scoreboard, unless player B counter plays a defense card.

During gameplay, defense cards are employed to lower the damage done by an attack card played against the player with the defense card. There are special defense cards (reverse and block cards) that provide players with special abilities. Reverse cards allow players to reverse an attack that is played against them back at the attacker. For example, only and in no way limiting, if Player A uses an attack card with a value of nine on Player B, and Player B uses a reverse card, then the health point score of Player A will move down nine spaces on the scoreboard.

The chosen first player may attack any single player, or multiple players of their choice, and can play 0-3 attack cards during their turn. The first player may also play 0-3 attack cards against a single other player. Each player attacked by the first player will have to subtract a point value of the attack card from their current health point. There are eighteen attack cards, including two sets thereof running from a value of one to a value of nine. During their respective turn, any player may choose to draw cards from the deck first, and then play their attack cards against one or more other players.

Upon commencement of a game with a current number of players being four, each player starts with a health point score of twenty health points, and is dealt five cards from the deck for their hand.

As noted, the first player can attack any player of their choice. Any of the other players can be targeted by the first player. For example, and in no way to be considered limiting, the first player has one three-point attack card and one four-point attack card in hand during his turn. The first player can use the three-point attack card to attack one player and can use the four-point attack card to attack a different player. Alternatively, the first player can use both of the attack cards on the same player.

During play of the game, each player in a sequence going around the play table, will try to reduce the health point score of any of the other players of they're choosing. To that end, a first player playing an attack card of a particular value against a second player will cause a deduction of health points from the current total of health points held by that second player. The current health point of each player is tracked on the score tracker card provided, which may be a pad of such score trackers or an erasable sheet.

Where a player runs out of health points, they are effectively out of the game, and that will leave the other players to continue to play. The health point score of players may be increased by the value of a health point card they draw from the deck during play.

As noted, also included in the deck of play cards are three types of defense cards. These defense cards may be played by a second player that is attacked by a first player, and they include protection cards, reverse cards, and block cards.

The protection card, when played, decreases the number value of the damage done to the health point of the player using it, as a defense to an attack card played by another player. For example, and in no way to be considered limiting, should one player play an attack card on a second player and the attack card has a value of five on it, a defense card played by the second player with a value of three will be subtracted from the attack card value, rendering a final attack value of two.

A reverse defense card may be played by a second player in response to an attack card played by a first player. In such an instance, the value of the attack card played by the first player toward the second player will be reversed and count toward the first player.

The block card, as noted, is the third type of defense card. Where a first player directs an attack card of any value toward a second player, the playing of the block card by the second player effectively negates the entire value of the attack card previously played.

Using the cards in their hands and those drawn during their respective turns by the players, the play will continue until only one player has a positive health score. That player wins.

The game may also be provided and played in digital form, wherein software operating to the task of playing the game with multiple players will operate to allow game play. Rather than individual cards and player score sheets, the digital version may employ a display screen for each player that depicts their current health and the current cards they have in their hand for gameplay. The software may operate to depict the game being played on a single screen for all players to view or on individual screens of the computing devices of the players. Individual depictions will work well where the players are not at the same location and playing virtually online.

The game software will operate in electronic memory of a computer, server, or computing device having an operatively coupled processor and network communications as needed to communicate with the players at a single location or multiple locations. The software operating to the tasks of game play will operate to change scores, change score sheets, depict indicia on one or a plurality of display screens representative of individual players and their current health score, their turn, and the other steps and tasks required of the physical card game for digital game play.

As to electronic memory or computer-readable media for the system herein, any combination of one or more computer-usable or computer-readable media, be it transitory or non-transitory, may be employed for operation of the software and assessment system herein. Such, for example and in no way limiting, can include computer-readable media and may include one or more of a portable computer diskette, a hard disk, a random access memory device, a read-only memory device, an erasable programmable read-only memory (EPROM or Flash memory) device, a portable compact disc read-only memory device, an optical storage device, and other electronic memory magnetic storage devices. Software or computer program code for carrying out the individual and sequential operations and airflow assessments of the present invention may be written in any combination of one or more programming languages.

The steps or method of operation and/or execution of the various modes and tasks of the

system in digital mode will employ software operating to enable play and to follow the same rules as the manual mode of the game herein. Each player will have their turn, and the increasing and decreasing health scores of each respective player may be calculated and displayed on an ongoing basis as the game progresses. Upon the occurrence of only one player with health points remaining, the software will operate to declare that player the winner.

With respect to the above description, before explaining at least one preferred embodiment of the herein disclosed card game and method of play in detail, it is to be understood that the card game invention is not limited in its application to the details of construction and to the arrangement of the components in the following description or illustrated in the drawings. The card game invention herein described is capable of other embodiments, and of being practiced and carried out in various ways, which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other card game decks and playing systems for carrying out the several purposes of the present disclosed card game device and method. It is important, therefore, that the claims be regarded as including such equivalent construction and methodology, insofar as they do not depart from the spirit and scope of the present invention.

As used in the claims to describe the various inventive aspects and embodiments, “comprising” means including, but not limited to, whatever follows the word “comprising.” Thus, use of the term “comprising” indicates that the listed elements are required or mandatory, but that other elements are optional, and may or may not be present. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with, or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of this invention to provide an interactive card game for multiple players where the object of the game is to be the last player with a positive health score.

It is an object of this invention to provide an interactive game which is easily played by multiple players.

It is a further object of this invention to provide such a game which may be played manually with cards and scoring, and is easy to play.

It is yet an additional object of this invention to provide a game for multiple players which may be played digitally, wherein software operating to play the game according to the rules of the game provides a digital version which is playable locally or over a network from remote individual player locations.

Other objects, features, and advantages of the presently disclosed game, as well as the advantages thereof over existing prior art, will become apparent from the description to follow, and are accomplished by the steps and rules described hereinafter, described in the following detailed description, which fully discloses the invention, but should not be considered as placing limitations thereon.

### BRIEF DESCRIPTION OF DRAWING FIGURES

FIG. 1 shows a front view of the deck of cards provided to the players to play the game, The Last One Standing.

FIG. 2 shows a front view of an attack card, which is one type of the cards provided in the deck of FIG. 1 in the form of an attack card.

FIG. 3 depicts an optional special type of health point card of FIG. 4, playable to revive a current health point of a player using it to get back to twenty or full strength.

FIG. 4 shows a view of a health point card, which is another of the cards provided in the deck of FIG. 1 for user play.

FIG. 5 depicts the three types of defense cards from the deck of FIG. 1, that the players may use for defensive moves during the game.

FIG. 6 shows the score tracker provided to keep track of the current health point of each player.

FIG. 7 depicts another mode of a score tracker card which is includes characters for each player.

FIG. 8 shows a mode of the game herein which is digital and operates with computer software running to the task of generating the steps of the game and scoring and depicting such on a digital display.

### DETAILED DESCRIPTION OF THE PREFERRED EMBODIMENTS OF THE INVENTION

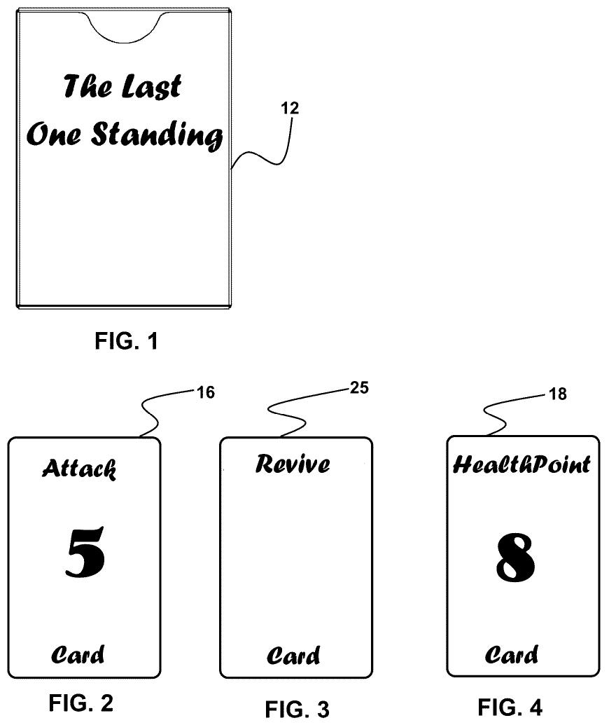

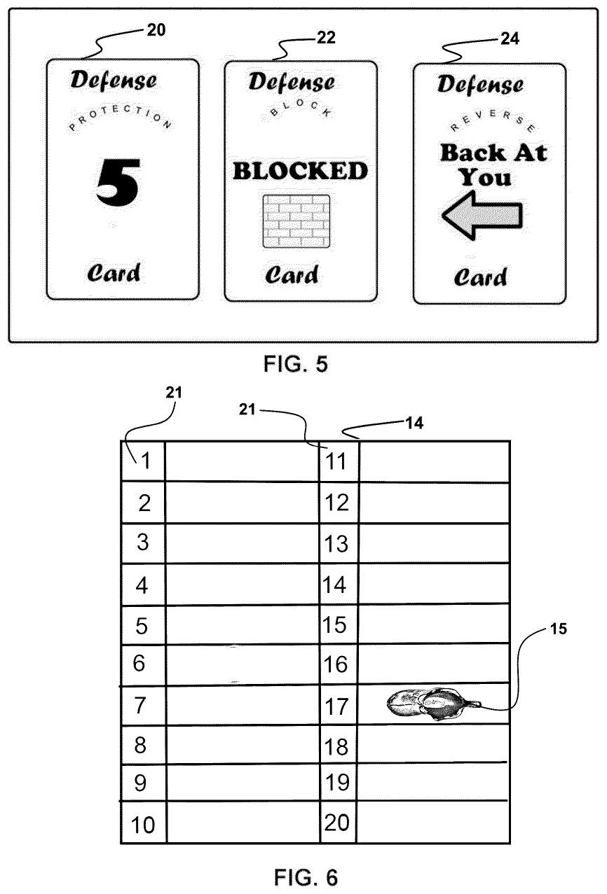

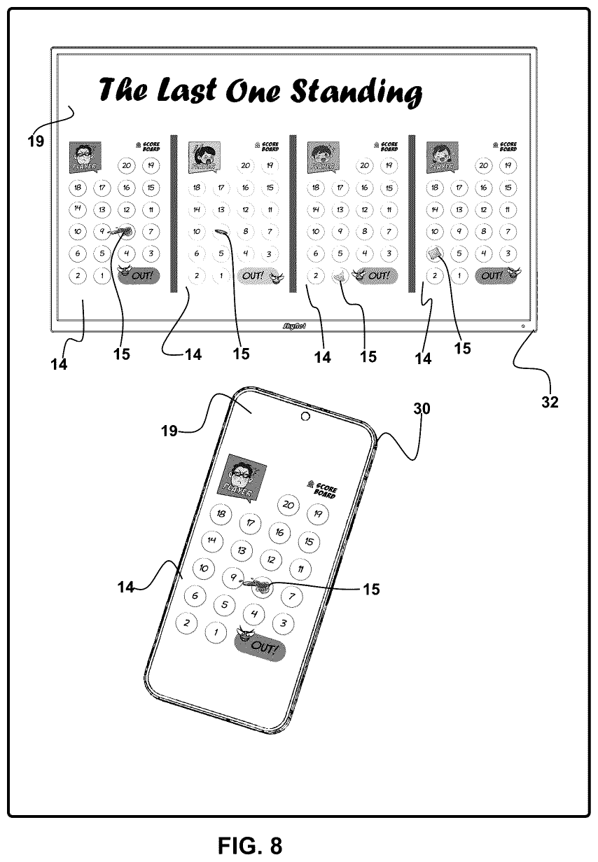

Now referring to drawings in FIGS. 1-8, wherein similar components are identified by like reference numerals. There is seen in FIG. 1, the deck of cards 12 provided for play of the game currently entitled, The Last One Standing. The title infers the goal of the game, which is in order to win, a player must be the final player who has a positive health point score when others have none.

As noted above, there are provided four types of playing cards in the playing deck 12. The deck 12 is sized for play of the game by 2-4 players.

At the beginning of the game, each player is provided a starting health point score of twenty, which the dealer, or each player, where electronic, the computer software will note on the score tracker sheet 14 correlating to each respective player. Thereafter, each player may track on their own respective score tracker sheet 14, a current health point score.

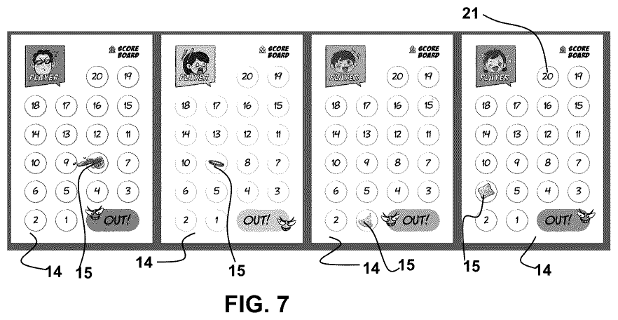

An example of such is shown in FIGS. 6 and 7, where such is shown by positioning a player token 15 associated with each player on their current health point score. In a digital version software operating to the task may depict the token 15 on a computer display 19. As attacks from other players reduce the health point score of any player, the attacked player's token 15 will be physically moved on the score tracker sheet 14 accordingly to depict their current health point score 21 between one and twenty. In the absence of the score tracker sheet 14, a pencil or pen and paper may be used to do the mathematical additions and subtractions.

Also, at the start of the game, one player acting as the dealer will deal a beginning hand consisting of five cards from the deck 12 which has been shuffled. Randomly, in each hand, each player receives any number of the three types of cards from the deck 12 in their beginning hand of five cards.

A first type of such cards from the deck 12 may be an attack card 16. The player having such attack cards 16 in their hand, upon their turn of play, may employ them to attack the health point score of another player. The numerical value of the attack cards 16 may be from one to nine, and the numerical value on the attack card 16 played by a first or an attacking player, will be deducted from the health point score 21 of the second or the attacked player against whom the attack card 16 is played.

Also included in the deck 12 are health point cards 18. The health point cards 18 in the deck 12 have values running between one and five. There is also a max-up version of the health point card 18, which essentially has a value of twenty, as it will move any player playing it to a health point score 21 of twenty.

A player possessing a health point card 18 may play it during a turn, to increase their current health point score 21 by the numerical value of the health point card 18 they choose to play from the cards in their hand. Upon play of a health point card 18, such will increase the current health point score of the player playing it, on the health point score tracker sheet 14.

The maximum health point 21 of any player is twenty, irrespective of the point score of a health point card 18 they play. For example, playing a health point card 18 with a value of eight, where the current health point of a player using it is fifteen, will only raise their health point back to twenty.

Additionally, included in the deck 12 in the cards that may be dealt to a player, are a group of defense cards. Defense or protection cards 20 may be played by any player under attack by another player. This occurs as noted above, where a first player plays an attack card 16 directed against a second player. On such an occurrence, the second player may reduce the damage to their respective health point score 21 caused by a numerical value of the attack card 16 played by the first player, by the value of the defense card 20 countered by the second player. Thus, the health point score 21 of the second player will only be reduced by the value of the attack card 16 minus the value of the defense protection card 20.

As an example, and in no way to be considered limiting, if the attacking player uses an attack card 18, the second or attacked player can use a defense card 20 to reduce the attack point value. But the second player cannot gain points, nor would the first player be reduced by any points in that interaction. For example, the second player is attacked by the first player with an attack card 16 with a value of three, and the second player plays a defense card 20 with a value of five; both players'health points remain unchanged.

Another set of defense cards included in the deck 12 are defense block cards 22. The defense block card 22 may be played by an attacked player when being attacked by a first or attacking player who is using an attack card 16. When played by the player being attacked, the numerical value of the attack card 16 played by a first, or attacking player, is blocked. Thus, the effective loss of health point score 21 of the second player being attacked is zero.

The deck of cards 12 also includes a plurality of defense cards, which are defense reverse cards 24. During play, when an attacking player directs an attack card 16 against an attacked player, the attacked player may counter by playing a defense reverse card 24. Upon such an occurrence, the health point score 21 of the attacking player who played the attack card 16 against the attacked player deploying the defense reverse card 24, has their health point score 21 reduced by the numerical value of the attack card 16 that they played.

During play of the game, the players will play the cards from their hand sequentially around the play table. During such play, the object will be to play will be to be the last player left with a positive health point score 21. Players will thus, during their turn, employ the attack cards 16 from their hand to attempt to reduce the health point score 21 of any other player in the game. Each player will have their health point score 21 constantly updated on the health point score sheet 14, depending upon the outcome of an attack card 16 played against them, and any defense card they were able to play, or any health point card 18 they played.

During gameplay, each player may play or discard up to three cards during their turn. Also, during a turn of each player, they may choose to take two more cards from the deck 12 if they still have cards not yet played in their hand. Alternatively, if they have no cards in their hand, they may draw five cards from the deck 12.

The maximum number of cards in the hand of each player is ten. Once a player reaches this maximum, they may either start playing the cards without picking cards from the deck 12, or drop two cards first before picking new cards from the deck. For example, if a player has nine cards in their hand, they may only pick one card from the deck 12, before playing their cards on their turn.

Players may play a defense card 20-24 at any given time when an attack card 16 is played against them by another player. If all cards in the discard pile are used, the dealer will shuffle the discarded/used cards for reuse as the deck 12. The max level of HP for every player is 20.

The end of the game is reached when only one player has a positive health point score 21 on the score sheet 14, and the other players'health point scores have been rendered to zero. Finally, optionally, the deck 12 may also include a revive card 25, which may be played by a player to revive their health point score to the maximum of 20.

Shown in FIG. 7 is another mode of a score tracker card 14, which includes characters for each player. The health point score 21 markers are shown from one to twenty. During play, the token 15 would be moved to the number equating to the current health point score 21 of that player after each turn.

As noted, the game herein may be electronic using software operating in electronic memory accessible by a computing device such as a computer or server. The software will operate to perform all the steps and tasks of the game herein noted above, and may display the score tracker cards 14 for the players on one or a plurality of displays, such as those shown in FIG. 1 wherein a smartphone 30 or similar portable computing device may depict such to each individual player. Where played at the same venue for multiple players, the digital or electronic version may also perform all the steps and tasks herein and may, for example, depict the score tracker cards 14 of all the players on a video display 32.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations, and substitutions are included within the scope of the invention as defined by the following claims.

What is claimed:

1. A method of playing a multi-player card game comprising the steps of:
a) utilizing a deck of cards having attack cards having a numerical value for lowering a health point score of another player, defense cards for reducing the numerical value of a said attack card, and health point cards having a numerical value for increasing a current health point score of a player;
b) for each of a plurality of players, assigning a respective health point score above zero to each player;
c) dealing a hand of five cards to each player from said deck of cards;
d) having a player become an attacking player and play one or a plurality of said attack cards against an attacked player chosen by said attacking player, where said numerical value of said attack cards will reduce a respective said health point score of said attacked player;
e) allowing said attacked player to counterplay a said defense card for reducing the numerical value of said attack card played by said attacking player to a deduction value;
f) reducing said health point score of said attacked player by said deduction value;
g) continuing play sequentially, allowing each of said plurality of players to act as a said attacking player against another attacked player chosen thereby;
h) continuing to allow each said attacked player to counterplay a said defense card for reducing the numerical value of a said attack card played against them to said deduction value; and
i) continuing to reduce said health point score of said attacked players by said deduction value until all but one player has a said health score point score of zero;
j) declaring the one player with a said health point score which is above zero, the winner.

2. The method of playing a multi-player card game of claim 1, comprising the additional steps of:
allowing players who have health point cards in their hand to play such on their turn and thereby increase their respective health point score by a numerical value of said health point card played.

3. The method of playing a multi-player card game of claim 1, comprising the additional steps of:
including blocking cards in said defense cards, said blocking cards acting for an attacked player to block the attack card played against them by an attacking player, thereby reducing said deduction value to zero.

4. The method of playing a multi-player card game of claim 2, comprising the additional steps of:
including blocking cards in said defense cards, said blocking cards acting for an attacked player to block the attack card played against them by an attacking player, thereby reducing said deduction value to zero.

5. The method of playing a multi-player card game of claim 1, comprising the additional steps of:
including reverse cards in said defense cards, said reverse cards acting for an attacked player to reverse the attack by an attacking player, where said numerical value of said attack card will reduce a respective said health point score of said attacking player.

6. The method of playing a multi-player card game of claim 2, comprising the additional steps of:
including reverse cards in said defense cards, said reverse cards acting for an attacked player to reverse the attack by an attacking player, where said numerical value of said attack card will reduce a respective said health point score of said attacking player.

7. The method of playing a multi-player card game of claim 3, comprising the additional steps of:
including reverse cards in said defense cards, said reverse cards acting for an attacked player to reverse the attack by an attacking player, where said numerical value of said attack card will reduce a respective said health point score of said attacking player.

8. The method of playing a multi-player card game of claim 4, comprising the additional steps of:
including reverse cards in said defense cards, said reverse cards acting for an attacked player to reverse the attack by an attacking player, where said numerical value of said attack card will reduce a respective said health point score of said attacking player.

9. The method of playing a multi-player card game of claim 1, comprising the additional steps of:
including a max-up card in said health point cards;
allowing players who have a max-up card in their hand to play such on their turn and thereby increase their respective health point score back to twenty.

10. The method of playing a multi-player card game of claim 3, comprising the additional steps of:
including a max-up card in said health point cards;
allowing players who have a max-up card in their hand to play such on their turn and thereby increase their respective health point score back to twenty.

11. The method of playing a multi-player card game of claim 5, comprising the additional steps of:
including a max-up card in said health point cards;
allowing players who have a max-up card in their hand to play such on their turn and thereby increase their respective health point score back to twenty.

12. The method of playing a multi-player card game of claim 7, comprising the additional steps of: including a max-up card in said health point cards;
allowing players who have a max-up card in their hand to play such on their turn and thereby increase their respective health point score back to twenty.

13. The method of playing a multi-player card game of claim 1, comprising the additional steps of:
employing a processor, and a non-transitory, computer-readable medium communicably coupled to the processor and storing software instructions that, when executed by the processor, cause the processor to perform steps a through j; and
to depict on one or a plurality of video display screens the current health point scores of players during the game.
